(19) United States
(12) Patent Application Publication
(10) Pub. No.: US 2015/0319577 A1
(43) Pub. Date: Nov. 5, 2015

(54) POSITION DETERMINATION USING A WIRELESS SIGNAL

(71) Applicant: QUALCOMM Incorporated, San Diego, CA (US)

(72) Inventors: Christopher Brunner, San Diego, CA (US); Victor Kulik, San Jose, CA (US)

(21) Appl. No.: 14/748,856

(22) Filed: Jun. 24, 2015

Related U.S. Application Data
(62) Division of application No. 12/621,310, filed on Nov. 18, 2009.

(51) Int. Cl. H04W 4/02; H04W 24/08

(52) U.S. Cl. CPC H04W 4/023; H04W 24/08; H04W 4/027; H04W 4/026

(57) ABSTRACT

A mobile station determines its position using measured parameters of a wireless signal to improve a satellite positioning system (SPS) enhanced dead reckoning based position estimate. The mobile station uses SPS enhanced dead reckoning to estimate a current position. The mobile station receives wireless signals from a plurality of access points and determines the round trip time. The estimated position of the mobile station is improved based on estimated positions of the plurality of access points and wireless signal based distance estimates from the plurality of access points that are determined using a channel model and the round trip time for the wireless signals.

### CROSS REFERENCE TO RELATED APPLICATIONS

This application is a continuation of U.S. application Ser. No. 12/621,310, entitled “Position Determination Using A Wireless Signal,” Nov. 18, 2009, which is assigned to the assignee hereof and is incorporated herein by reference.

### BACKGROUND

Obtaining accurate position information for mobile stations, such as cellular or other wireless communication devices, is becoming prevalent in the communications industry. The Global Positioning System (GPS) offers an approach to providing wireless mobile station position determination. A GPS user can derive precise navigation information including three-dimensional position, velocity and time of day through information gained from satellite vehicles (SVs) in orbit around the earth. The signals that are received from the SVs are typically rather weak. Therefore, in order to determine the position of the receiver, the receiver must be sufficiently sensitive to receive these weak signals and interpret the information that is represented by them.

One limitation of current GPS receivers is that their operation is limited to situations in which multiple satellites are clearly in view, without obstructions, and where a good quality antenna is properly positioned to receive such signals. As such, they normally are unusable in areas with blockage conditions, such as where there is significant foliage or building blockage (e.g., urban canyons) and within buildings.

One manner to compensate for limitations in GPS positioning is the use of dead reckoning. Dead reckoning is used to estimate a current position based on a previously determined position and the direction and distance traveled from that previously determined position, e.g., as measured by motion sensors or other sensors. Dead reckoning measurements, however, may suffer from drift errors. For example, drift in an accelerometer may affect the measured distance traveled. Further environmental factors, such the horizontal travel of an escalator may affect the distance measurement. Additionally, Earth magnetic field disturbances (anomalies) may affect magnetic measurements producing an error in the direction traveled. Consequently, the use of dead reckoning results in position determination that becomes increasingly inaccurate over time. Thus, improvements for position determination of mobile stations are desired.

### SUMMARY

A mobile station determines its position using measured parameters of a wireless signal to improve a satellite positioning system (SPS) enhanced dead reckoning based position estimate. The mobile station uses SPS enhanced dead reckoning to estimate a current position. The mobile station receives wireless signals from a plurality of access points and determines the round trip time. The estimated position of the mobile station is improved based on estimated positions of the plurality of access points and wireless signal based distance estimates from the plurality of access points that are determined using a channel model and the round trip time for the wireless signals.

A wireless signal location database is used to assist in the determination of the position of a mobile station. The wireless signal location database may be generated within a mobile station or in an online server that is accessed by mobile stations. The database is generated by receiving measured parameters of a wireless signal and the estimated position of the measurement locations. The distance between the wireless signal access point and the measurement locations is estimated, e.g., based on the round trip time or path loss of the wireless signals. The positions of the wireless signal access points are then estimated based on the estimated distances and the estimated positions of the measurement locations. The estimated position of the wireless signal access point and a corresponding confidence level are stored in the database. The stored positions of the wireless signal access points and the corresponding confidence level may be used to assist in estimating the position of the mobile station using wireless signals from the access points.

### BRIEF DESCRIPTION OF THE DRAWING

FIG. 1 illustrates a mobile station that is capable of determining its position using wireless signals from, e.g., wireless communication access points or cellular towers.

FIG. 2 is a block diagram illustrating a system in which a mobile station may determine its position using wireless signals.

FIG. 3 is a block diagram of the mobile station capable of determining its position using wireless signals.

FIG. 4 is a flow chart showing a method of determining the position of a mobile station using wireless signals in combination with dead reckoning.

FIG. 5 illustrates a building with two wireless access points.

FIG. 6 is a flow chart showing a method of generating a wireless signal location database in the mobile station.

FIG. 7 is a block diagram of a server that may generate a database and provide position information to a mobile station based on parameters of wireless signals received by the mobile station.

FIG. 8 is a flow chart of establishing a server database for assisting in mobile station position determination using wireless signals received by the mobile station.

### DETAILED DESCRIPTION

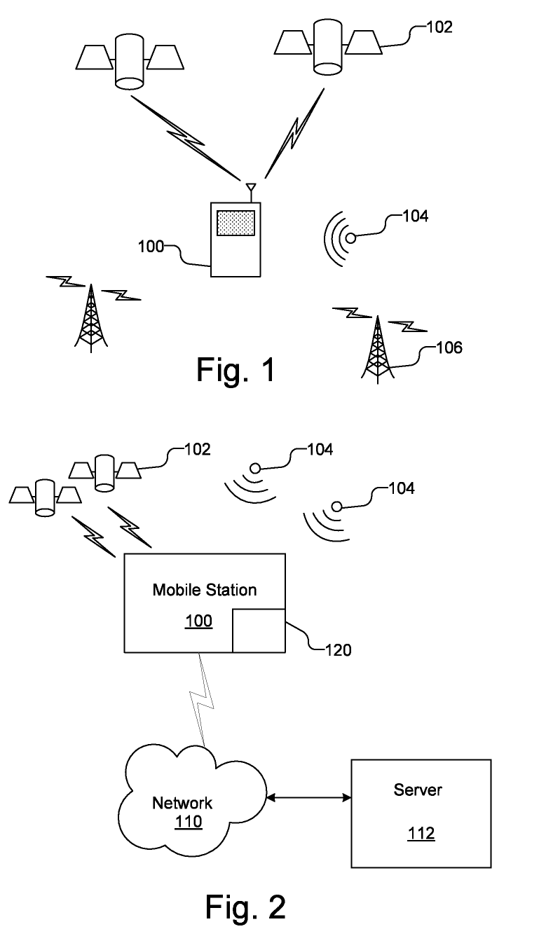

FIG. 1 illustrates a mobile station 100 that is capable of determining its position using wireless signals from, e.g., wireless communication access points 104 or cellular towers 106, sometimes collectively referred to as access points. The positioning information determined using wireless signals may be used along with other positioning mechanisms, such as satellite positioning systems (SPS), using satellite vehicles 102, as well as dead reckoning from motion sensors, such as a magnetometer and accelerometer. Position determination using wireless signals may be particularly useful when SPS systems are unavailable, such as when the mobile station is within a building or other environments where there is little or no SPS coverage. The wireless signal position determination may be used to reduce dead reckoning error in scenarios with weak or no SPS coverage, thereby increasing the accuracy of applications such as pedestrian or other types of navigation and location based advertising.

As used herein, a mobile station (MS) refers to a device such as a cellular or other wireless communication device, personal communication system (PCS) device, personal navigation device (PND), Personal Information Manager (PIM), Personal Digital Assistant (PDA), laptop or other suitable mobile device which is capable of receiving wireless communication and/or navigation signals, such as navigation positioning signals. The term “mobile station” is also intended to include devices which communicate with a personal navigation device (PND), such as by short-range wireless, infrared, wireline connection, or other connection—regardless of whether satellite signal reception, assistance data reception, and/or position-related processing occurs at the device or at the PND. Also, “mobile station” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile station.”

A satellite positioning system (SPS) typically includes a system of transmitters positioned to enable entities to determine their location on or above the Earth based, at least in part, on signals received from the transmitters. Such a transmitter typically transmits a signal marked with a repeating pseudo-random noise (PN) code of a set number of chips and may be located on ground based control stations, user equipment and/or space vehicles. In a particular example, such transmitters may be located on Earth orbiting satellite vehicles (SVs) 102, illustrated in FIG. 1. For example, a SV in a constellation of Global Navigation Satellite System (GNSS) such as Global Positioning System (GPS), Galileo, Glonass or Compass may transmit a signal marked with a PN code that is distinguishable from PN codes transmitted by other SVs in the constellation (e.g., using different PN codes for each satellite as in GPS or using the same code on different frequencies as in Glonass).

In accordance with certain aspects, the techniques presented herein are not restricted to global systems (e.g., GNSS) for SPS. For example, the techniques provided herein may be applied to or otherwise enabled for use in various regional systems, such as, e.g., Quasi-Zenith Satellite System (QZSS) over Japan, Indian Regional Navigational Satellite System (IRNSS) over India, Beidou over China, etc., and/or various augmentation systems (e.g., an Satellite Based Augmentation System (SBAS)) that may be associated with or otherwise enabled for use with one or more global and/or regional navigation satellite systems. By way of example but not limitation, an SBAS may include an augmentation system(s) that provides integrity information, differential corrections, etc., such as, e.g., Wide Area Augmentation System (WAAS), European Geostationary Navigation Overlay Service (EGNOS), Multi-functional Satellite Augmentation System (MSAS), GPS Aided Geo Augmented Navigation or GPS and Geo Augmented Navigation system (GAGAN), and/or the like. Thus, as used herein an SPS may include any combination of one or more global and/or regional navigation satellite systems and/or augmentation systems, and SPS signals may include SPS, SPS-like, and/or other signals associated with such one or more SPS.

The mobile station 100 is not limited to use with an SPS for position determination, as position determination techniques described herein may be implemented in conjunction with various wireless communication networks, including cellular towers 106 and from wireless communication access points 104, such as a wireless wide area network (WWAN), a wireless local area network (WLAN), a wireless personal area network (WPAN), and so on. Further the mobile station 100 may access online servers to obtain data, such as satellite images, using various wireless communication networks via cellular towers 106 and from wireless communication access points 104, or using satellite vehicles 102 if desired. The term “network” and “system” are often used interchangeably. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, Long Term Evolution (LTE), and so on. A CDMA network may implement one or more radio access technologies (RATs) such as cdma2000, Wideband-CDMA (W-CDMA), and so on. Cdma2000 includes IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may be an IEEE 802.11x network, and a WPAN may be a Bluetooth network, an IEEE 802.15x, or some other type of network. The techniques may also be implemented in conjunction with any combination of WWAN, WLAN and/or WPAN.

FIG. 2 is a block diagram illustrating a system in which a mobile station 100 may determine its position using wireless signals. As illustrated, the mobile station 100 is capable of determining its position using a SPS system including satellite vehicles 102. Additionally, the mobile station 100 is capable of determining its position when the SPS system is unavailable using motion sensors 120, such as a magnetometer and accelerometer and a previous absolute position estimate. The mobile station 100 receives wireless signals from wireless access point 104 (or from cellular towers 106 illustrated in FIG. 1) and uses those signals to assist in the position determination. By way of example, the wireless signals that may be used include WLAN, UMTS, GSM, Bluetooth or a combination of these. The mobile station 100 may measure the strength or the round trip time of signals for wireless signals and compares those values to a database of wireless fingerprints to determine a wireless signal based position estimate of the mobile station 100. By way of example, the database of wireless locations, e.g., wireless signal fingerprints or wireless access point positions, may be generated and stored in memory in the mobile station 100. Alternatively, the mobile station may access and query a server 112 with a wireless location database through a network 110, e.g., via wireless access point 104 or cellular tower 106.

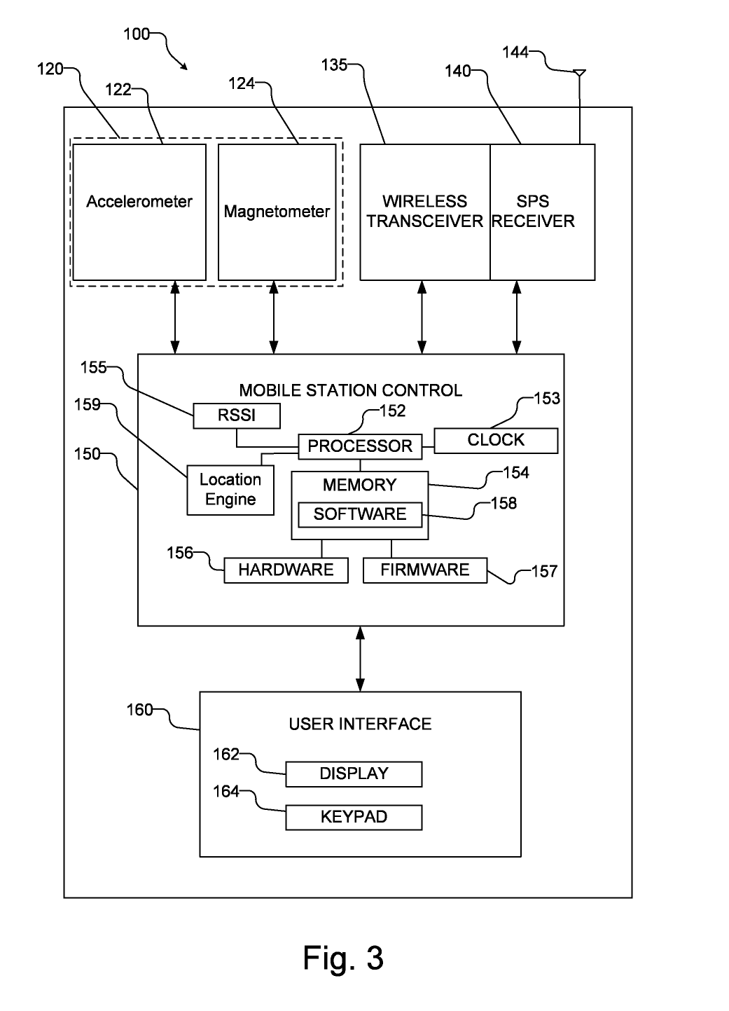

FIG. 3 is a block diagram of the mobile station 100. As illustrated in FIG. 3, the mobile station 100 may include motion sensors 120, which may include an accelerometer 122 and magnetometer 124. The motion sensors 120 may include additional or alternative devices, such as gyroscopes, pressure sensors, or camera, if desired. In case of a vehicle, bicycle or wheel chair navigation additional type of sensors may be a vehicle odometer or wheel tick sensor. Sensors such as magnetometer 124, as well as gyroscopes, pressure sensors, or camera are considered a motion sensor 120 herein as they may assist in the determination of motion, e.g., with respect to direction, distance or change in altitude. Mobile station 100 includes a satellite positioning system (SPS) receiver 140 that receives signals from a SPS satellites 102 (FIG. 1) via an antenna 144. Mobile station 100 also includes a wireless transceiver 135, which may be, e.g., a wireless network radio receiver/transmitter that is capable of sending and receiving communications to and from wireless access point 104 via antenna 144. The mobile station 100 may also include a cellular modem separate from or part of the wireless transceiver 135, which is capable of sending and receiving communications to and from a cellular tower 106.

The accelerometer 122 and magnetometer 124 in the motion sensors 120, SPS receiver 140, and wireless transceiver 135 are connected to and communicate with a mobile station control 150. The mobile station control 150 accepts and processes data from the motion sensors 120, SPS receiver 140, and wireless transceiver 135 and controls the operation of the devices. The mobile station control 150 may be provided by a processor 152 and associated memory 154, a clock 153, hardware 156, software 158, and firmware 157. The mobile station 150 further includes a received signal strength indicator system (RSSI) 155 that may be separate from or part of the processor 152. The RSSI system 155 determines the signal strength of any radio signal received by the wireless transceiver 135 provides the measured signal strength to the processor 152. Additionally, the processor 152 may control the wireless receiver 135 to produce a signal to an access point and monitor the time to receive a response to determine a round trip time for the wireless signal.

The mobile station 150 further includes a location engine 159, which is illustrated separately from processor 152 for clarity, but may also be within the processor 152. The location engine 159 processes the positioning data, including the SPS data, the dead reckoning data, and wireless signal data, and the wireless location database to determine the position of the mobile station 100. The wireless location database may be stored in memory 154 or, alternatively, in a server database that is accessed via the wireless transceiver 135. Moreover, in some embodiments, the location engine may also be located on a server, e.g., server 112 in FIG. 2, in network 110 that is accessed and queried via the wireless transceiver 135.

It will be understood as used herein that the processor 152 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the mobile station, and is not to be limited to any particular type of memory or number of memories, or type of media upon which memory is stored.

The mobile station 100 also includes a user interface 160 that is in communication with the mobile station control 150, e.g., the mobile station control 150 accepts data and controls the user interface 160. The user interface 160 may include a display 162 that displays images produced by a camera 130 as well as control menus and positional information. The user interface 160 further includes a keypad 164 or other input device through which the user can input information into the mobile station 100. In one embodiment, the keypad 164 may be integrated into the display 162, such as a touch screen display. The user interface 160 may also include, e.g., a microphone and speaker, e.g., when the mobile station 100 is a cellular telephone.

The methodologies described herein may be implemented by various means depending upon the application. For example, these methodologies may be implemented in hardware 156, firmware 157, software 158, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 154 and executed by the processor 152. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

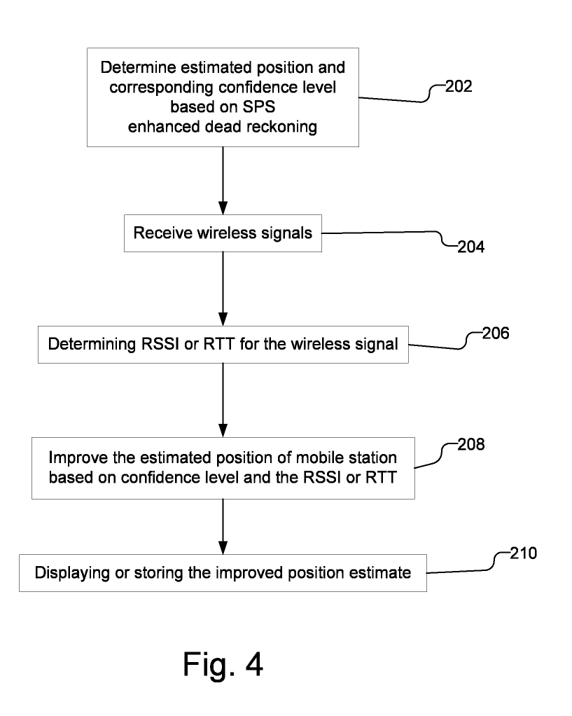

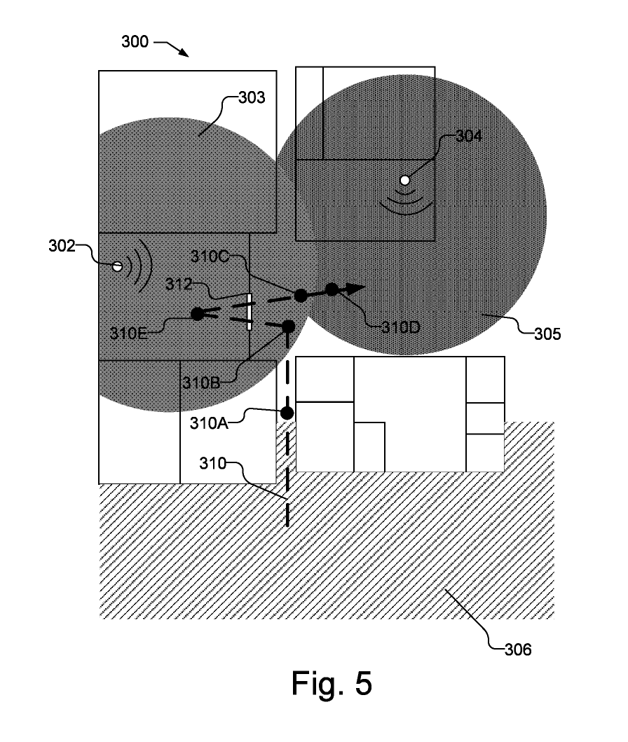

FIG. 4 is a flow chart showing a method of determining the position of a mobile station using wireless signals in combination with dead reckoning. As illustrated in FIG. 4, an estimated position of the mobile station is determined (202) along with the corresponding confidence level. The estimated position may be determined, e.g., using SPS enhanced dead reckoning. For example, a position of the mobile station may be determined using an SPS system, e.g., data from a SPS system is received by the SPS receiver 140 (FIG. 3) from which processor 152 or location engine 159 calculates the position. An improved position estimate of the mobile station can be obtained by collecting previous and current SPS based position fixes and combining these absolute position estimates with relative position estimates based on dead reckoning from data received by the motion sensors (120). If desired, for instance in the event of weak or no SPS coverage, the position estimate may be enhanced using other techniques and devices including using data from other various wireless communication networks, including cellular towers 106 and from wireless communication access points 104 combined with relative position estimates based on dead reckoning from data received by the motion sensors (120).

For illustrative purposes, FIG. 5 shows a building 300 with two wireless access points 302 and 304 with their respective wireless signals 303 and 305. The building 300 may include several rooms, such as stores in a mall. Outside of the building 300, the coverage area 306 of an SPS system is illustrated with hatching, which extends into the building a small distance. The path 310 traveled by a mobile station through the building is illustrated with a dotted line. While the mobile station is outside the building the mobile station has adequate SPS system coverage and thus obtains an accurate position fix. When the mobile station enters the building (position 310A), the position of the mobile station is estimated based on combined dead reckoning with progressively less accurate SPS position estimates. The estimated position from dead reckoning may be generated using the motion sensors 120, such as accelerometer 122 and magnetometer 124, in the mobile station 100, as illustrated in FIG. 3. The position data from the motion sensors 120 is provided to the processor 152 or location engine 159. The estimated position is thus generated based on the last known accurate position and the accumulated position data from the motion sensors 120. The dead reckoning position estimate, however, will normally drift, e.g., 1 m to 5 m over 100 m. Moreover, if there are magnetic disturbances that affect the magnetometer or if horizontal escalators are used the drift of the dead reckoning position estimate may be even more serious.

To correct for drift in the dead reckoning position estimate, wireless signals received by the mobile station are used to assist in the position determination. For example, referring to FIG. 5, the mobile station receives wireless signals 303 from access point 302 at position 310B, and wireless signals 305 from access point 304 at position 310D. At position 310C, the mobile station can receive both wireless signals 303 and 305. The measured parameters of the wireless signals 303 and 305 may be used to assist in estimating the position of the mobile station.

Referring to FIG. 4, when wireless signals are received (204), e.g., by the wireless transceiver 135, parameters of the wireless signals are measured, which is sometimes referred to as a wireless fingerprint. For example, the signal strength of the wireless signals may be determined (206), e.g., by the (RSSI) 155. Alternatively, or additionally, the round trip time of the wireless signals may be determined (208). By way of example, the processor 152 may control the wireless transceiver to produce a wireless signal to a local access point, which responds with a return signal. The processor 152 uses the clock 153 to determine the round trip time (RTT) of the wireless signal. For example, the RSSI and/or RTT of three or more access points may be measured. The position estimate for the mobile station is improved using the measured parameter of the wireless signal, e.g., the RSSI or RTT, (208) and the improved position estimate is displayed, e.g., on display 162, or stored in memory 154 (210) to be used by an application. For example, the position estimate may be improved by fusing an SPS enhanced dead reckoning position estimate with a position estimate associated with a wireless fingerprint taking into account confidence levels associated with the respective position estimates.

In order to improve the position estimate using a measured parameter, e.g., the RSSI or RTT of the wireless signal (208), the measured parameter is compared to a wireless signal fingerprint, which may be stored in the mobile station 100 or, alternatively, stored in an external database. A wireless signal fingerprint is defined as RSSI and/or round trip time measurements from all received access points. The wireless signal fingerprint is approximately unique with respect to position.

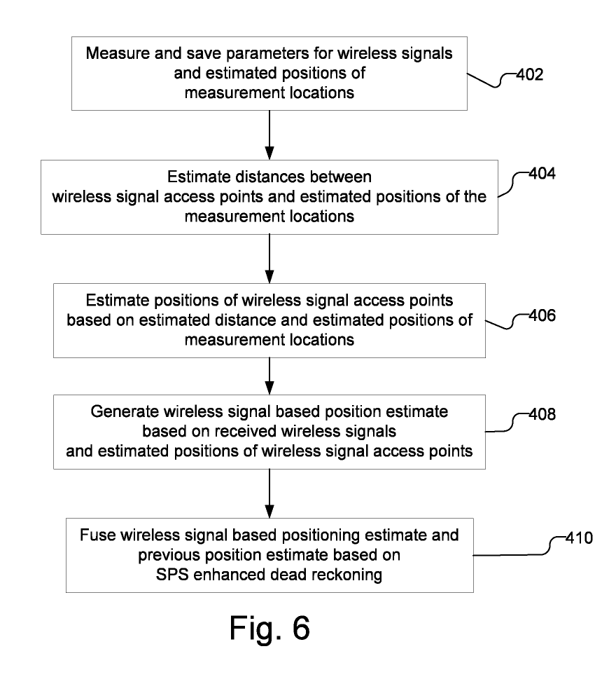

In one embodiment, the wireless signal fingerprint is stored in the mobile station 100. FIG. 6 is a flow chart showing a method of generating a wireless signal location database using a mobile station, the wireless signal location may be wireless fingerprints or wireless access point positions. As illustrated, parameters of the wireless signals are measured and stored (402), e.g., in memory 154 (FIG. 3) in the mobile station 100, for a plurality of measurement locations. Additionally, the estimated positions for the measurement locations is determined and stored (402). For example, as the mobile station moves into the coverage of a wireless access point, e.g., at position 310B in FIG. 5, the RSSI and/or RTT for the wireless signal 303 produced by the wireless access point 302 is measured and stored along with the position estimate of the mobile station. Additionally, the confidence level for the position estimated may be determined and stored. The position estimate for the measurement locations may be determined based on SPS enhanced dead reckoning or SPS enhanced dead reckoning fused with wireless signal based position estimates. The confidence in the position estimate may be a function of distance or time from the last SPS position fix.

The distance between the wireless signal access points and the estimated positions for the measurement locations is estimated (404). Estimation of distance from the wireless access point to the measurement locations may be determined using a channel model and may be based on round trip time measurements and/or path-loss measurements. An estimated distance that is based on path-loss measurements assumes knowledge of wireless access point transmit power. In a channel, multipath should be taken into account or the distance estimates will be impacted. Wireless signals that take an indirect path to the receiver or are reflected somewhere, will have the distance estimate affected by the round trip time estimate and the RSSI. When the mobile station moves from a non-line-of-sight position to a line-of-sight position with respect to an access point, the distance estimate based on the wireless signal will change more than the change of position due to dead reckoning would indicate. For example, in FIG. 5, the mobile station may move through a glass door 312 from position 310B to position 310E, which will result in a large increase in the RSSI, indicated that the large change in position has occurred. However, the change in the dead reckoning position would indicate only a small change in position. The distance estimate is the difference between consecutive position estimates and, thus, is considered to be accurate because dead reckoning is accurate over small amounts of time, i.e., little or no drift has occurred. Thus, changes in at least one of the measured round trip time and path loss may be compared to changes in the estimated positions for the corresponding measurement locations and the comparison may be used to modify the channel model used to estimate distance between the access points. For example, in one embodiment, a transition distance may be determined based on dead reckoning and based on wireless signals, e.g., by taking the difference in distance estimates based on wireless signals during the transition is generated. The estimated distance to the access point based on wireless signals is corrected by the difference in distance estimates that is greater than the dead reckoning transition distance. Alternatively or additionally, a lower confidence would be attached to wireless signal based distance estimates that are affected by multipath, as determined by inconsistencies with changes in the dead reckoning positions. Additionally, lower confidence can be attached to the distance estimate if the position estimate of the mobile station has been obtained via dead reckoning with less confidence.

The positions of the wireless access points may then be estimated based on a number of estimated distances and the estimated positions of the measurement locations (406). The confidence levels for the estimated positions of the measurement locations, as well as confidence levels for the estimated distances, may also be used in the determination of the access point locations. For example, estimated positions or distance estimates that are less reliable can be taken into account during minimization by attenuating their impact on the cost function. Additionally, confidence levels for the estimated positions of the wireless signal access points may be determined. The determined access point locations may be stored in a database in memory 154 for use while the mobile station is at the present location, e.g., building 300. The determined access point locations may also be stored for future use, e.g., when mobile station returns to the building 300.

With the database of access point locations generated, a wireless signal based position estimate of the mobile station may then be determined based on measured parameters (RSSI and/or RTT) of received wireless signals and the estimated positions of the wireless signal access points (408). The wireless confidence level that corresponds to the wireless signal based position estimate may also be determined. For example, the mobile station position may use the RSSI and RTT to estimate the distance to the access points, as described above. Using the estimated distance and the estimated position of the access point, the position of the mobile station may be determined, e.g., using trilateration.

The estimated position of the mobile station, e.g., from step 202 in FIG. 4, is improved by fusing the estimated position with the wireless signal based position estimate using the wireless confidence level and the confidence level associated with the estimated position (410) and the fused position estimate may be stored in memory 154 as the current position of the mobile station and/or displayed in display 162. For example, the wireless signal based position estimate may be provided to the location engine 159, e.g., with an estimate of the confidence of the position estimate, and the location engine 159 may combine the wireless signal based position estimate with position estimates based on the previous position estimate based on SPS enhanced dead reckoning. It should be understood that that the previous position estimate may also be an SPS enhanced dead reckoning position that is fused with a previously determined wireless signal based position estimate. Similarly, as discussed above, the estimated positions of the wireless signal measurement locations in step 402) may be based on SPS enhanced dead reckoning positions that are fused with previously determined wireless signal based position estimates.

Additionally, the mobile station may access a server, e.g., server 112 in FIG. 2, via the wireless transceiver 135 and upload the estimated access point locations for other mobile stations to access. In one embodiment, the confidence estimates of the access point locations is also provided and the server improves the access point location estimates using access point location and confidence estimates obtained from other mobile stations. In use, the mobile station may access server 112 when entering a location, e.g., building 300, and query the server for access point location data, which the mobile station may use for navigation as discussed above.

As discussed above, the wireless signal locations may be stored in an external database, as opposed to being produced and stored in the mobile station. For example, the mobile station 100 may receive a wireless signal and measure one or more parameters, such as RSSI or RTT, which is provided to an external server 112 on network 110. The server 112 in response may return a corresponding wireless signal based position estimate with a confidence level if desired. The wireless signal based position estimate (with confidence level) returned from the server 112 may be provided to the location engine 159 along with the previously determined position estimate, e.g., based on dead reckoning, and a fused position estimate may be generated using the confidence levels from the different position estimates as discussed above. For example, a fused position estimate may be generated by weighting position estimates based on their respective confidence levels, e.g., higher confidence level is given more weight, before combining the position estimates, e.g., weighted average, to obtain the final fused position estimate. The server 112 may be accessed periodically, e.g., based on time or movement, to update the position estimate.

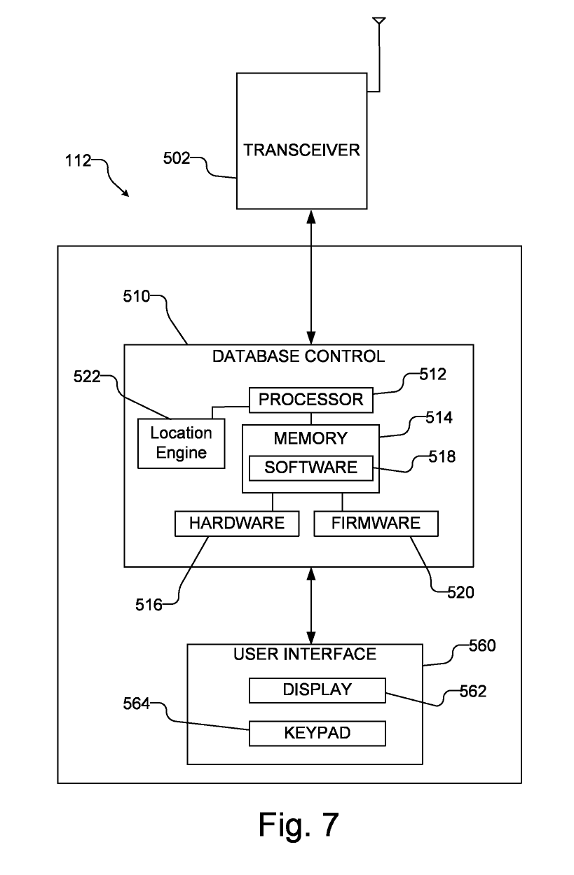

FIG. 7 is a block diagram of a server 112 that may provide position information to a mobile station based on parameters of wireless signals received by the mobile station. As illustrated in FIG. 7, the server 112 is coupled to a transceiver 502, which connects the server 112 to network 110 (FIG. 2). The transceiver 502 is illustrated as a wireless transceiver, but it should be understood that it may be wired. If desired, the transceiver may be internal to the server 112. The transceiver 502 is connected to and communicates with a server control 510. The server control 510 accepts and processes data from the transceiver 502 controls the operation of the device. The server control 510 may be provided by a processor 512 and associated memory 514, hardware 516, software 518, and firmware 520. The server 112 further includes a location engine 522 that processes the data received from the transceiver 502 and the wireless location database stored in memory 514 to determine a position to be transmitted in response. The server 112 may also includes a user interface 530, including a display 532 and keypad 534, that is in communication with the server 112, e.g., the server control 510 accepts data and controls the user interface 530.

As with the processor 152 in the mobile station, it will be understood as used herein that the processor 512 can, but need not necessarily include, one or more microprocessors, embedded processors, controllers, application specific integrated circuits (ASICs), digital signal processors (DSPs), and the like. The term processor is intended to describe the functions implemented by the system rather than specific hardware. Moreover, as used herein the term “memory” refers to any type of computer storage medium, including long term, short term, or other memory associated with the server, and is not to be limited to any particular type of memory or number of memories, or type of media upon which memory is stored.

The methodologies described herein may be implemented by various means depending upon the application. For example, these methodologies may be implemented in hardware 516, firmware 520, software 518, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in memory 514 and executed by the processor 512. Memory may be implemented within the processor unit or external to the processor unit. As used herein the term “memory” refers to any type of long term, short term, volatile, nonvolatile, or other memory and is not to be limited to any particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. That is, the communication apparatus includes transmission media with signals indicative of information to perform disclosed functions. At a first time, the transmission media included in the communication apparatus may include a first portion of the information to perform the disclosed functions, while at a second time the transmission media included in the communication apparatus may include a second portion of the information to perform the disclosed functions.

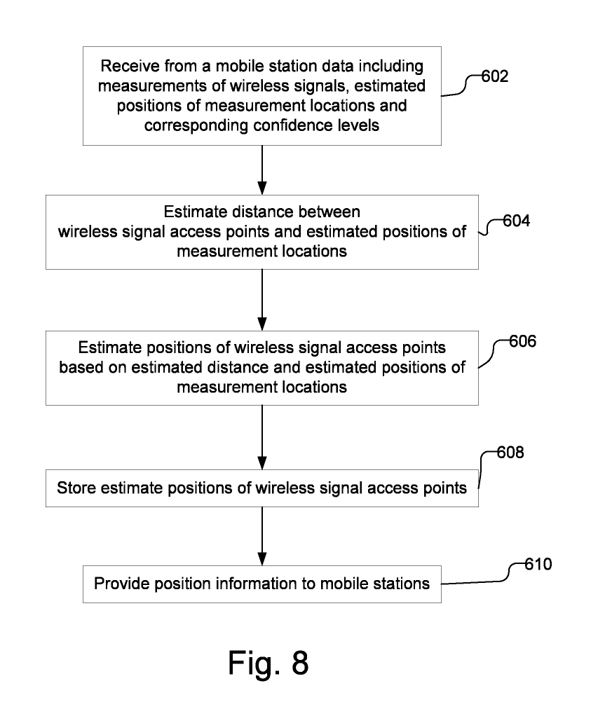

FIG. 8 is a flow chart of establishing a server database for assisting in mobile station position determination using wireless signals received by the mobile station. As illustrated in FIG. 8, the server receives mobile station data such as wireless fingerprint information, position estimates for the measurement locations and confidence levels for the position estimates (602). Once the database is established, the position estimates of measurement locations and confidence levels may no longer be needed. The wireless fingerprint information may include, e.g., the RSSI and/or RTT for wireless signals received by the mobile station, e.g., for three or more access points, as discussed above. The position estimates of the measurement locations may be based on SPS enhanced dead reckoning or SPS enhanced dead reckoning that is fused with wireless signal based position estimates. The mobile station may also provide time stamps of the wireless signal measurements and a mobile station identification to enable distance estimates between consecutive measurements from the same mobile station when estimating wireless locations.

To save battery life and bandwidth in mobile stations, the estimated positions and wireless locations may be provided to the server for the purpose of data base building if motion sensors 120 in the mobile station indicate movement, if the area is covered by wireless signals, and if the area is not yet accurately reflected in the database. For example, it may be evident that the area is not yet accurately reflected in the database when the mobile station does not receive a position estimate after submitting a measured wireless signal parameter. In addition, to save battery life in the mobile station, the present methods may be extended to areas that have both SPS and wireless signal coverage so that position determination in the mobile station can take place without using the SPS system, thereby using less power and incurring little or no delay in obtaining an initial position fix, which can take several minutes using an SPS system.

Based on the received data, the distance between wireless signal access points and the estimated positions of the measurement locations for the wireless signals is determined using a channel model (604). The distance estimation may be performed similar to the estimation described in block 404 (FIG. 6), except that data from multiple mobile stations may be used. In one embodiment, distance estimates are made only for mobile station positions that have a high degree of confidence. Distance estimates that are less reliable can be taken into account during minimization by attenuating their impact on the cost function.

The positions of the wireless signal access points can then be estimated based on the estimated distances and the estimated positions of the measurement locations (606). Additionally, positions in the wireless signal fingerprint can then be estimated based on the estimated distances and the mobile station positions (606). The estimated positions of the access points and/or the fingerprints (along with corresponding confidence levels) is stored (608), e.g., in a database in memory 514. The server may provide position information to the mobile station (610). For example, where the database contains the estimated positions of the access points, the server may provide estimated positions of the access points in response to receiving the information from the mobile station (602). The mobile station may then use the provided estimates of the positions of the access points (with corresponding confidence levels) along with the channel model and measurements of the wireless signals to determine a wireless based position estimate, which can then be fused with an SPS enhanced dead reckoning position estimate, as discussed above. Alternatively or additionally, the database may contain the wireless signal fingerprint and the corresponding wireless based position estimates for different locations within the wireless fingerprint and corresponding confidence estimates. The server may provide the wireless based position estimate and confidence level to the mobile station (610) and the mobile station may fuse wireless based position estimate with an SPS enhanced dead reckoning position estimate. Alternatively, the server may fuse the SPS enhanced dead reckoning position estimate provided by the mobile station (602) with the wireless based position estimate and provided the fused position estimate to the mobile station.

Due to the large number of fingerprints constraining the position of the access points, e.g., distance to access points derived from pilot strength measurements as well as well as the relative position of fingerprints to one another derived from dead reckoning), the estimated positions of the access points will be accurate. The position estimates corresponding to the fingerprints themselves will be affected to some extent by multi-path. Therefore, these position estimates of the mobile stations will be noisy relative to the access point location estimates. However, as long as the access points are accurately positioned, the position estimates of the fingerprints will not have a bias caused by inaccurate access point positions.

Although the present invention is illustrated in connection with specific embodiments for instructional purposes, the present invention is not limited thereto.

Various adaptations and modifications may be made without departing from the scope of the invention. Therefore, the spirit and scope of the appended claims should not be limited to the foregoing description.

What is claimed is:

1. A method comprising:
determining with satellite positioning system enhanced dead reckoning an estimated position of a mobile station;
receiving wireless signals from a plurality of access points;
determining a round trip time for the wireless signals; and
improving the estimated position of the mobile station based on estimated positions of the plurality of access points and wireless signal based distance estimates from the plurality of access points that are determined using a channel model and the round trip time for the wireless signals.

2. The method of claim 1, wherein improving the estimated position of the mobile station comprises:
accessing a server and providing the round trip time for the wireless signals and receiving from the server a wireless signal based position estimate of the mobile station; and
fusing the wireless signal based position estimate and the estimated position determined with satellite positioning system enhanced dead reckoning.

3. The method of claim 1, further comprising accessing a server and providing the estimated position and the round trip time for the wireless signals.

4. The method of claim 1, further comprising:
obtaining the estimated positions of the plurality of access points for the wireless signals;
determining a wireless signal based position estimate of the mobile station based on the estimated positions of the plurality of access points and received wireless signals and the wireless signal based distance estimates from the plurality of access points;
wherein improving the estimated position of the mobile station comprises fusing the estimated position of the mobile station with the wireless signal based position estimate.

5. The method of claim 4, wherein obtaining the estimated positions of the plurality of access points for the wireless signals comprises accessing a server and receiving the estimated positions of the plurality of access points for the wireless signals from the server.

6. The method of claim 4, wherein obtaining the estimated positions of the plurality of access points for the wireless signals comprises:
determining the round trip time for the wireless signals at a plurality of measurement locations, wherein estimated positions for the plurality of measurement locations are determined based on satellite positioning system enhanced dead reckoning;
determining wireless signal based distance estimates between an access point and the estimated positions for the plurality of measurement locations using the channel model;
estimating a position of the access point based on the wireless signal based distance estimates and the estimated positions for the plurality of measurement locations.

7. The method of claim 6, wherein the estimated positions for the plurality of measurement locations are determined based on satellite positioning system enhanced dead reckoning fused with wireless signal based position estimates and wherein the estimated position of the mobile station comprises a fused wireless signal based and satellite positioning system enhanced dead reckoning based position estimate.

8. The method of claim 6, wherein determining the wireless signal based distance estimates between the access point and the estimated positions for the plurality of measurement locations using the channel model comprises measuring round trip time for the wireless signals and using the measured round trip time to determine the wireless signal based distance estimates.

9. The method of claim 8, further comprising comparing changes in the measured round trip time to changes in estimated positions for corresponding measurement locations determined based on satellite positioning system enhanced dead reckoning and using the compared changes to modify the channel model used to estimate distance.

10. The method of claim 6, further comprising providing dead reckoning confidence levels corresponding to the estimated positions for the plurality of measurement locations, wherein estimating the position of the access point uses the dead reckoning confidence levels corresponding to the estimated positions for the plurality of measurement locations.

11. The method of claim 1, wherein the wireless signals are one of WLAN, UMTS, LTE, GSM and Bluetooth.

12. The method of claim 1, wherein determining with satellite positioning system enhanced dead reckoning the estimated position of the mobile station comprises using data from a magnetometer and an accelerometer.

13. The method of claim 1, wherein determining with satellite positioning system enhanced dead reckoning the estimated position of the mobile station comprises using data from at least one of a gyroscope, pressure sensor, camera, odometer, and wheel tick sensor.

14. A mobile station comprising:
a satellite positioning system receiver that provides positioning data;
at least one sensor providing dead reckoning data;
a wireless transceiver that receives and transmits wireless signals;
a processor connected to the satellite positioning system receiver to receive the positioning data, the at least one sensor to receive the dead reckoning data, and the wireless transceiver, wherein the processor is configured to determine an estimated position with satellite positioning system enhanced dead reckoning, determine a round trip time for the wireless signals received by the wireless transceiver from a plurality of access points, improve the estimated position based on estimated positions of the plurality of access points and wireless signal based distance estimates from the plurality of access points that are determined using a channel model and the round trip time.

15. The mobile station of claim 14, wherein the processor is configured to improve the estimated position by being configured to control the wireless transceiver to transmit the round trip time to a server and in return receive a wireless signal based position estimate from the server and to fuse the wireless signal based position estimate and the estimated position determined with satellite positioning system enhanced dead reckoning.

16. The mobile station of claim 14, wherein the processor is further configured to control the wireless transceiver to transmit the estimated position and the round trip time to a server.

17. The mobile station of claim 14, wherein the processor is further configured to obtain the estimated positions of the plurality of access points for the wireless signals; determine a wireless signal based position estimate of the mobile station based on the estimated positions of the plurality of access points and received wireless signals and the wireless signal based distance estimates from the plurality of access points, wherein the processor is configured to improve the estimated position of the mobile station by being configured to fuse the estimated position of the mobile station with the wireless signal based position estimate.

18. The mobile station of claim 17, wherein the processor is configured to control the wireless transceiver to receive the estimated positions of the plurality of access points for the wireless signals.

19. The mobile station of claim 17, wherein the processor is configured to obtain the estimated position of the plurality of access points for the wireless signals by being configured to, for each access point, determine the round trip time for wireless signals at a plurality of measurement locations, and to determine estimated positions of the plurality of measurement locations based on the positioning data and the dead reckoning data; to determine wireless signal based distance estimates between an access point and the estimated positions for the plurality of measurement locations using the channel model, and to determine estimated positions for each access point based on the wireless signal based distance estimates and the estimated positions for the plurality of measurement locations.

20. The mobile station of claim 19, wherein the processor is configured to determine the estimated positions of the plurality of measurement locations by being configured to use positioning data, dead reckoning data and wireless signal based position estimates and wherein the estimated position of the mobile station comprises a fused wireless signal based and satellite positioning system enhanced dead reckoning based position estimate.

21. The mobile station of claim 19, wherein the processor is configured to determine the wireless signal based distance estimates between the access point and the estimated positions for the plurality of measurement locations using the channel model by being configured to measure at least one of the round trip time and path loss based on the measured round trip time to determine the wireless signal based distance estimates.

22. The mobile station of claim 21, wherein the processor is further configured to compare changes in at least one of the measured round trip time to changes in estimated positions for corresponding measurement locations determined based on satellite positioning system enhanced dead reckoning and use the compared changes to modify the channel model used to estimate distance.

23. A mobile station comprising:
means for determining an estimated position of the mobile station using satellite positioning system enhanced dead reckoning;
means for receiving wireless signals from a plurality of access points;
means for determining a round trip time for the wireless signals;
means for improving the estimated position of the mobile station based on estimated positions of the plurality of access points and wireless signal based distance estimates from the plurality of access points that are determined using a channel model and the round trip time for the wireless signals.

24. The mobile station of claim 23, wherein the means for improving the estimated position of the mobile station comprises means for providing the round trip time for the wireless signals to a server and means for receiving a wireless signal based position estimate from the server and a means for fusing the wireless signal based position estimate and the estimated position determined with satellite positioning system enhanced dead reckoning.

25. The mobile station of claim 23, further comprising:
means for obtaining the estimated positions of the plurality of access points for the wireless signals; and
means for determining a wireless signal based position estimate of the mobile station based on the estimated positions of the plurality of access points and received wireless signals and the wireless signal based distance estimates from the plurality of access points;
wherein the means for improving the estimated position of the mobile station comprises means for fusing the estimated position of the mobile station with the wireless signal based position estimate.

26. The mobile station of claim 25, wherein the means for obtaining the estimated positions of the plurality of access points for the wireless signals comprises:
means for determining the round trip time for the wireless signals at a plurality of measurement locations, wherein estimated positions for the plurality of measurement locations are determined based on satellite positioning system enhanced dead reckoning;
means for determining wireless signal based distance estimates between an access point and the estimated positions for the plurality of measurement locations using the channel model; and
means for estimating a position of the access point based on the wireless signal based distance estimates and the estimated positions for the plurality of measurement locations.

27. A tangible and non-transitory computer-readable medium including program code stored thereon, comprising:
program code to determine an estimated position of a mobile station based on satellite position system enhanced dead reckoning;
program code to determine a round trip time for wireless signals from a plurality of access points;
program code to improve the estimated position based on estimated positions of the plurality of access points and wireless signal based distance estimates from the plurality of access points that are determined using a channel model and the round trip time.

28. The tangible and non-transitory computer-readable medium of claim 27, wherein the program code to improve the estimated position comprises program code to control a wireless transceiver to transmit the round trip time to a server and program code to fuse a wireless signal based position estimate received from the server with the estimated position determined with satellite positioning system enhanced dead reckoning.

29. The tangible and non-transitory computer-readable medium of claim 27, further comprising:
program code to obtain the estimated positions of the plurality of access points for the wireless signals; and
program code to determine a wireless signal based position estimate based on the estimated positions of the plurality of access points and received wireless signals and the wireless signal based distance estimates from the plurality of access points;
wherein the program code to improve the estimated position comprises program code to fuse the wireless signal based position estimate with the estimated position determined with satellite positioning system enhanced dead reckoning.

30. The tangible and non-transitory computer-readable medium of claim 29, wherein the program code to obtain the estimated positions of the plurality of access points for the wireless signals comprises:
program code to determine the round trip time for wireless signals at a plurality of measurement locations;
program code to determine estimated positions of the plurality of measurement locations based on satellite position system enhanced dead reckoning; and
program code to determine wireless signal based distance estimates between an access point and the estimated positions for the plurality of measurement locations using the channel model.
